(19) United States
(12) Patent Application Publication
(10) Pub. No.: US 2018/0137470 A1
(43) Pub. Date: May 17, 2018

(54) VEHICLE WORK ENVIRONMENT

(71) Applicant: Uber Technologies, Inc., San Francisco, CA (US)

(72) Inventors: Richard Donnelly, Pittsburgh, PA (US); David McAllister Bradley, Pittsburgh, PA (US); James Lee Epifano, San Francisco, CA (US); Justin Wayne Ho, San Francisco, CA (US)

(21) Appl. No.: 15/351,209

(22) Filed: Nov. 14, 2016

(51) Int. Cl. G06Q 10/10; H04L 12/18; G06Q 50/14; H04L 29/08; H04L 29/06

(52) U.S. Cl. CPC G06Q 10/1095; H04L 12/1818; H04L 63/08; H04L 67/30; G06Q 50/14

(57) ABSTRACT

A vehicle work environment provides capabilities for working and participating in meetings while riding in a vehicle such as a driverless autonomous vehicle (AV). In some examples, mobile meeting features are added to a calendaring system so that a meeting organizer can schedule a teleconference or in-vehicle meeting while some or all participants in the meeting are commuting to/from work or another destination. When attempting to schedule a meeting, a transport facilitation system in communication with the calendaring system calculates optimal times when attendees can meet inside a vehicle or teleconference in multiple vehicles simultaneously. The transport facilitation system sends AVs to the pick-up addresses for the attendees. The AVs provide a vehicle work environment including secure audio and visual communications with a conferencing system between vehicles and any non-mobile participants. The vehicle work environment opens up more options for meetings and allows workers to spend their travel time productively.

### BACKGROUND

Commuters increasingly spend more of their time driving cars to and from work, which is time that could be spent productively as a passenger utilizing a transport arrangement service that provides autonomous vehicles or matches drivers with requesting users. Furthermore, companies have limited meeting spaces, and workers do not always work the same hours as their colleagues, making scheduling meetings difficult.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 illustrates an example transport facilitation system and calendaring system of a vehicle work environment, as described herein;

FIG. 2 illustrates an example transport facilitation system in communication with user devices and a fleet of vehicles, as described herein;

FIG. 3 illustrates a fleet of vehicles providing vehicle work environments for riders in communication with a conference system, as described herein;

FIG. 4 describes an example method of establishing profile information for employers and workers in a vehicle work environment, as described herein;

FIG. 5 describes an example method of a meeting organizer creating a meeting with mobile participants in a vehicle work environment, as described herein;

FIG. 6 describes an example method of facilitating a mobile meeting in a vehicle work environment, as described herein; and

FIG. 7 illustrates a computer system upon which example systems described herein may be implemented.

### DETAILED DESCRIPTION

According to examples, a mobile meeting system is provided for enabling multiple participants to schedule meetings to take place in one or more vehicle work environments managed by a transport facilitation service. The mobile meeting system can receive meeting proposals, retrieve travel profiles for desired participants that indicate blocks of time when the participants are traveling and available for the meeting, and transmit the travel profiles to a meeting organizer.

Example vehicle work environments provide capabilities for working and participating in meetings while riding in a vehicle such as a driverless autonomous vehicle (AV). In some examples, mobile meeting features are added to a calendaring system so that a meeting organizer can schedule a teleconference or in-vehicle meeting while some or all participants in the meeting are commuting to/from work or another destination. Employers can set up individual employee accounts and enter payment details; employees can update addresses, such as home and work addresses, as well as their usual commute times with the calendaring system. When attempting to schedule a meeting, a transport facilitation system in communication with the calendaring system calculates optimal times when attendees can meet inside a vehicle or teleconference in multiple vehicles simultaneously. The transport facilitation system provides these blocks of time to the calendaring system so that they appear to the meeting organizer as available times for mobile meetings.

When the time for a mobile meeting approaches, the transport facilitation system sends vehicles to the pick-up addresses for the attendees and notifies the attendees of the meeting. Based on the pick-up addresses, the transport facilitation system can identify a number of proximate available vehicles and transmit a transport invitation to one or more driver devices of the proximate available vehicles to service the pick-up requests. In other examples, the transport facilitation system sends driverless autonomous vehicles to pick up the meeting attendees. The vehicles, whether driverless or with a driver, can provide a vehicle work environment including secure audio and visual communications with a conferencing system between vehicles and any non-mobile participants (e.g., participants in a conference room or using a desktop computer in an office). The vehicle work environment opens up more options for meetings and allows workers to spend their travel time productively.

Among other benefits, a schedulable, reliable, in-vehicle work environment allows a transportation company to offer additional services to employers and employees. Employers get more minutes of work from their employees with extra productivity benefits that the in-vehicle work environment offers while paying the transportation company significantly less than the hourly rate of the employee. Employers also get on-demand expansion of meeting rooms and workspace resources through the ability to reserve secure, private spaces in autonomous vehicles. Employees get a transportation benefit that can be paid by the employer that is much safer than trying to make calls while driving. The vehicle work environment opens up a new ecosystem of conference, work hardware, and software tools to the transportation company, which can also benefit from bulk commercial arrangements with large corporations, reducing billing and credit card overhead compared to individual rider-funded models.

According to some examples, a mobile meeting system receives a request over a network from an organizer to propose a meeting between a number of participants. The system retrieves a travel profile for each of the participants and transmits the travel profiles over the network to the organizer. The travel profiles indicate one or more blocks of time when each participant is traveling and available for the meeting. These blocks of time in the travel profiles can be submitted by each of the plurality of participants.

In some examples, the mobile meeting system receives an indication for a mobile meeting and a meeting time from the organizer, schedules the mobile meeting at the meeting time, and selects one or more vehicles to pick up at least some of the participants prior to the meeting time. The travel profiles include addresses, such as a home address and a work address for each participant, and the one or more vehicles are sent to the appropriate address for each participant. In some variants, the one or more vehicles are selected optimally to coincide with each of the plurality of participants' travel profiles.

One or more aspects described provide for verifying identify information for the participants and establishing a secure networked meeting between the one or more vehicles at the meeting time, for example, through the use of a virtual private network (VPN).

As used herein, a computing device refers to devices corresponding to desktop computers, cellular devices or smartphones, personal digital assistants (PDAs), laptop computers, tablet devices, virtual reality (VR) and augmented reality (AR) devices such as VR or AR headsets, television (IP Television), wearable devices, etc. that can provide network connectivity and processing resources for communicating with the system over a network. A computing device can also correspond to custom hardware, in-vehicle devices, or on-board computers, etc. The computing device can also operate a designated application configured to communicate with network services.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

Numerous examples are referenced herein in context of an autonomous vehicle (AV) or self-driving vehicle. An AV and/or self-driving vehicle refers to any vehicle which is operated in a state of automation with respect to steering and propulsion. Different levels of autonomy may exist with respect to AVs. For example, some vehicles may enable automation in limited scenarios, such as on highways, provided that drivers are present in the vehicle. More advanced AVs and self-driving vehicles can drive without any human assistance from within or external to the vehicle.

System Descriptions

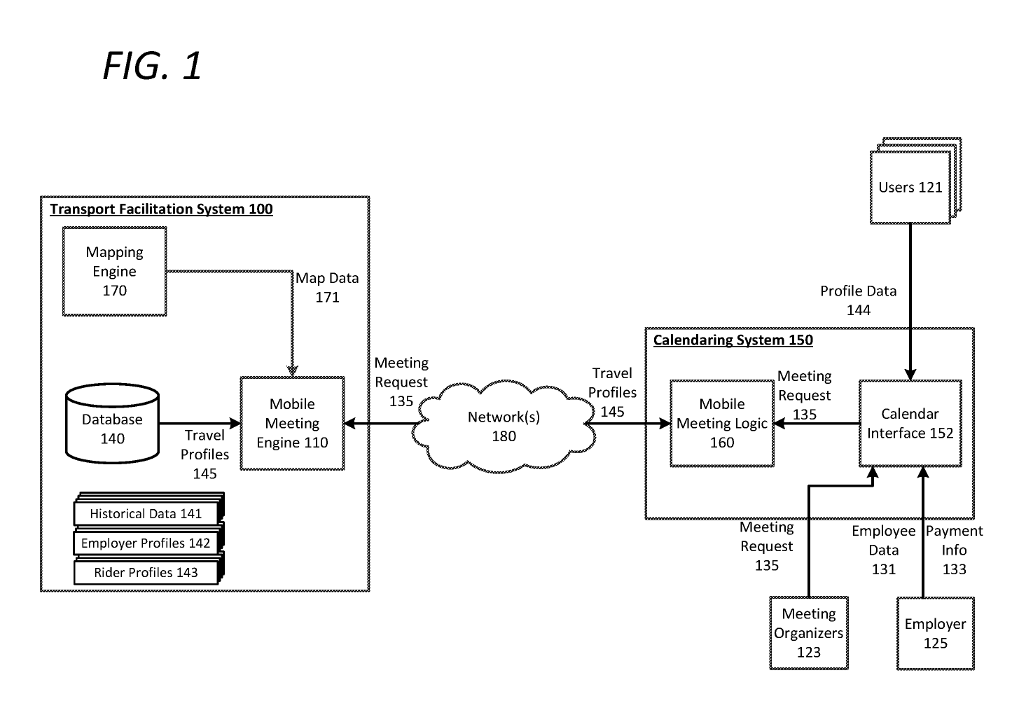

FIG. 1 is a block diagram illustrating an example transport facilitation system 100 and calendaring system 150 that support a vehicle work environment, as described herein. In some aspects, the calendaring system 150 is a software program that manages meetings, tasks, and availability across an organization for an employer 125, users 121, and meeting organizers 123. The calendaring system 150 can provide a calendar interface 152 to display calendars to users 121 and meeting organizers 123 and to accept input from the users 121 and meeting organizers 123, for example to create a meeting at a certain time and invite attendees to the meeting. It should be appreciated that calendaring system 150 can include additional components and interact with other computer systems not depicted in FIG. 1 for simplicity.

In general, calendaring system 150 provides a suite of tools that allow users 121 to schedule meetings between multiple participants. For example, a meeting organizer 123 can choose a day and time for a meeting and enter details such as a subject, location for the meeting, and text describing the purpose of the meeting. The calendaring system 150 can also access calendars that contain the availability of each of the desired participants and the availability of locations such as conference rooms in which to hold the meeting. Based on the time chosen for the meeting, some conference rooms may already be reserved, and some desired participants may not be in the office.

In one aspect, the calendaring system 150 includes mobile meeting logic 160 to communicate with transport facilitation system 100 in order to display mobile meeting options on the calendar interface 152 when a meeting organizer 123 is creating a meeting or updating an existing meeting. A mobile meeting engine 110 on the transportation facilitation system 100 calculates optimal times for when all attendees can meet while on the road (e.g., during a commute to or from work). Instead of just seeing a list of available rooms at the office on the calendar interface 152, the meeting organizer 123 also sees possible mobile meeting scenarios as optional “places” to hold the meeting.

Transport facilitation system 100 is an on-demand transportation arrangement service linking available drivers and/or autonomous vehicles (AVs) with requesting riders throughout a given region. In doing so, the transport facilitation system 100 (or “transport system”) can receive user requests for transportation via a designated rider application executing on the users' mobile computing devices. Based on an inputted pick-up location, the transport system can identify a number of proximate available vehicles and transmit a transport invitation to one or more driver devices of the proximate available vehicles to service the pick-up request. In the context of a vehicle work environment and calendaring system 150, transport facilitation system 100 calculates optimal times for when all attendees can meet while on the road and sends vehicles to the appropriate locations at the appropriate times to pick up the meeting participants.

Users 121, meeting organizers 123, and employer 125 can interact with the calendar interface 152 with various types of computing devices across the Internet or a local intranet. The calendaring system 150 can reside on a server located at the employer's place of business, on a remote server on the Internet, or as part of a larger office application. In one example, the functionality of the calendaring system 150 is provided through the transportation facilitation system 100 itself over network 180. In another example, an entity providing the transport facilitation system 100 makes the mobile meeting logic 160 available as a plug-in module for various types of calendaring systems 150.

In some aspects, an employer 125 can configure the calendaring system 150 to support mobile meeting logic 160 with the transport facilitation system 100 for its employees (i.e., users 121 and meeting organizers 123). In one implementation, an employer 125 can enable the mobile meeting feature in a calendaring system 150 customized for their company. In other implementations, employer 125 downloads a plug-in module for mobile meeting logic 160 and installs it into the calendaring system 150. Employers 125 provide employee data 131 for users 121 to have access to the mobile meeting feature in the calendaring system 150. Employee data 131 can include information that mobile meeting logic 160 uses to suggest meeting times and coordinate vehicles with the transport facilitation system 100, such as user credentials, home and work addresses, business hours, etc. Employer 125 can also enter payment info 133, such as a company credit card or bank account, to which transport facilitation system 100 bills rides that employees take. Employee data 131 and payment info 133 can be stored in a database 140 with the transport facilitation system 100 as an employer profile 142.

In one aspect, users 121 invited to participate in the mobile meeting feature are sent emails to confirm their registration and provide profile data 144. For example, users 121 can provide or update addresses on the calendar interface 152. Invited employees then enter their preferences for blocks of commute hours in which they may be available for in-commute conference meetings or general work presence. Combined with each employee's home and work addresses, these preferences are sent to the transport facilitation system 100 and added to a commute block table in a database 140. In other aspects, profile data 144 is stored locally with the calendaring system 150 in addition to or in lieu of storing it with transport facilitation system 100.

When an employee accesses the calendar interface 152 to schedule a meeting with other employees, calendaring system 150 prompts the meeting organizer 123 to add attendees, establish a time for the meeting, and choose a location for the meeting. In addition to the usual conference rooms available as locations for the meeting, mobile meeting logic 160 mines travel profiles 145, which include addresses and the commute blocks for each of the users 121 chosen for the meeting, and sends suggestions for multi-attendee mobile meeting options from the transport facilitation system 100 to the meeting organizer 123 on the calendar interface 152.

In some aspects, meeting organizer 123 can schedule a vehicle that has special office equipment, such as Wi-Fi, tables, virtual-reality equipment, video screens, etc. for use as a conference room. Thus, when scheduling a meeting, calendar interface 152 can present options to the meeting organizer 123 for types of vehicles and various productivity, security, and privacy options. For example, options may include one seat in a vehicle driven by a human driver, one seat in a public AV (for calls where the participant is just listening on headphones), private use of an AV, and private use of an AV in which all video/audio records inside the AV are deleted (or not recorded). AVs may have internal cameras and other equipment to ensure security, monitor ride quality, and identify people who cause damage to the AV. However, if the ride is sponsored by an employer, the employer may prefer that the internal camera is turned off and is willing to accept the risk that employees may cause damage to the vehicle. Privacy features may also include noise cancellation between seats (e.g., through noise cancelling emitters in headrests).

In some aspects, a meeting organizer 123 is any of the users 121, other persons who have access to create meetings in the calendaring system 150, or systems that can programmatically create meetings with the calendaring system 150. The meeting organizer 123 can be an attendee of the meeting or set up a meeting on behalf of other users 121. In addition, users 121 invited to the meeting can act as meeting organizers 123 and can suggest or directly invite additional participants, propose meeting locations, and arrange for mobile meetings for themselves or other participants through the calendar interface 152.

In order to generate the suggested mobile meeting options, mobile meeting engine 110 on the transport facilitation system 100 uses an algorithm to predict travel times and find overlapping time blocks in which participants are traveling. To determine the possibility of holding a meeting with multiple participants in the same vehicle, the mobile meeting engine 110 can utilize a mapping engine 170 to provide map data 171 and also retrieve historical data 141 from the database 140 that includes historical travel time information. Based on the pick-up addresses of two of the participants (e.g., a home address for a morning commute meeting), mobile meeting engine 110 predicts the travel time between the pick-up addresses from the map data 171 and historical data 141. If the predicted travel time is below an acceptable threshold, mobile meeting logic 160 displays an option for a shared ride meeting between the selected participants on the calendar interface 152. In some aspects, the acceptable threshold is an amount of time that allows a vehicle to pick up each of the shared ride meeting participants during their set commute blocks and also arrive at their destination address during their set commute blocks with enough time spent traveling for the meeting to take place. In other aspects, the acceptable threshold can extend commute blocks by a number of minutes in order to accommodate the shared ride meeting.

If the meeting organizer 123 creates a meeting request 135 for a shared ride meeting on the calendar interface 152, mobile meeting logic 160 can create meeting invitations with each invitation offset by the predicted travel time. For example, if the meeting organizer 123 creates a meeting request 135 for a 7:20 am meeting with a predicted travel time of 20 minutes between two participants, mobile meeting logic 160 can generate an invitation for a 7:00 am pick-up at the first participant's home address and an invitation for a 7:20 am pick-up at the second participant's home address. Upon receiving confirmation from the participants, mobile meeting engine 110 can log vehicle request orders for the meeting. In the above example, the mobile meeting engine 110 logs a request to send a vehicle to the first participant's home address by 7:00 am with further destinations of the second participant's home address and their work address.

To determine the possibility of holding a meeting with multiple participants in separate vehicles, the mobile meeting engine 110 analyzes travel profiles 145 for the meeting participants to find time blocks representing overlapping commute blocks between the participants. If there is an overlap large enough to accommodate the length of the proposed meeting, mobile meeting logic 160 displays options for a multi-vehicle mobile meeting on the calendar interface 152. For example, if the meeting organizer 123 creates a meeting request 135 for a multi-vehicle mobile meeting at 7:20 am, mobile meeting logic 160 can generate an invitation for a 7:20 am pick-up at the first participant's home address and an invitation for a 7:20 am pick-up at the second participant's home address. Upon receiving confirmation from the participants, mobile meeting engine 110 can log vehicle request orders for the meeting. In this example, the mobile meeting engine 110 logs two requests: the first to send a vehicle to the first participant's home address by 7:20 am, and the second to send a vehicle to the second participant's home address by 7:20 am.

When scheduling the meeting, transport facilitation system 100 can also provide meeting organizer 123 with a cost of the meeting/trip. The cost can be based on the pickup and destination locations as well as a predicted time of the trip and/or scheduled time of the meeting. The cost may also change based on the selection of the vehicle, features, or how much privacy is requested.

In other aspects, travel profiles 145 include meeting profiles that are created or modified in response to a meeting request 135. The meeting organizer 123 can create a meeting request 135 and propose a mobile meeting as the location for the meeting to one or more users 121 regardless of their normal travel schedules. For example, a first meeting organizer 123 creates a meeting with multiple attendees through the calendaring system 150 and chooses an office conference room as the location for the meeting. One of the attendees can then propose using a vehicle as the meeting location for that attendee and add additional attendees to the vehicle meeting location. Mobile meeting engine 110 can create or update a meeting profile for any attendees using the mobile meeting option.

Meeting profiles can include pickup addresses and destinations that are based on the meeting itself and not pre-stored in any particular person's travel profile 145. For example, a meeting between a salesperson and a client could take place in a vehicle en route to a sporting event. Meeting profiles can also include a list of addresses that should be visited during the meeting. For example, if a real estate agent is showing houses to a potential buyer, the real estate agent could schedule a meeting with a list of houses to visit, and the meeting organizer 123 could schedule when to pick up the real estate agent and the buyer, schedule when to visit each house (and in what order), and provide specific route details to the AV to get from house to house.

When scheduling the meeting, the meeting organizer 123 can include one or more addresses in the meeting request 135, and mobile meeting logic 160 can schedule the AV (and automatically take care of routing) as well as interact with other systems based on the provided information for additional functionality. For example, calendaring system 150 can interface with centralized showing servers that allow real estate agents to schedule showings when homeowners are away. The real estate agent can input the addresses and mobile meeting logic 160 can take care of scheduling visits and routing between locations based on output from the centralized showing servers. In addition, the centralized showing servers can provide information to mobile meeting logic 160 to dynamically update the schedule and routing, such as in response to the real estate agent running behind schedule or a homeowner cancelling a showing because they will still be in the house.

In order to protect the privacy of users 121, the calendar interface 152 can hide specific addresses from meeting organizers 123. For example, other users' home addresses may be shown to meeting organizers 123 as simply “home” or a broader region such as a city or neighborhood.

Although the examples described are for a meeting between two participants, mobile meeting logic 160 and the mobile meeting engine 110 can predict travel times and schedule mobile meetings between any number of participants using the same logic. In addition, a meeting request 135 can include both a shared ride meeting and a multi-vehicle mobile meeting. For example, two participants can ride in one vehicle with a third participant in a separate vehicle tele-conferenced with the other vehicle. Furthermore, the transport facilitation system 100 and mobile meeting engine 110 can operate to pick up single users 121 without requiring a meeting with other participants. For example, one person can schedule a meeting alone to take advantage of an autonomous vehicle's office capabilities, thereby creating a mobile workplace. Depending on a type of vehicle and options chosen, mobile meeting engine 110 can determine whether the mobile meeting qualifies to be paid for by the employer 125.

Furthermore, mobile meeting logic 160 can schedule meetings and rides using pickup and destination locations outside of home and work addresses and work commutes. For example, a salesperson can pick up a client, and the two can have a scheduled meeting in an AV (making full use of the video screens and other technology available in the AV) while on their way to a sporting event.

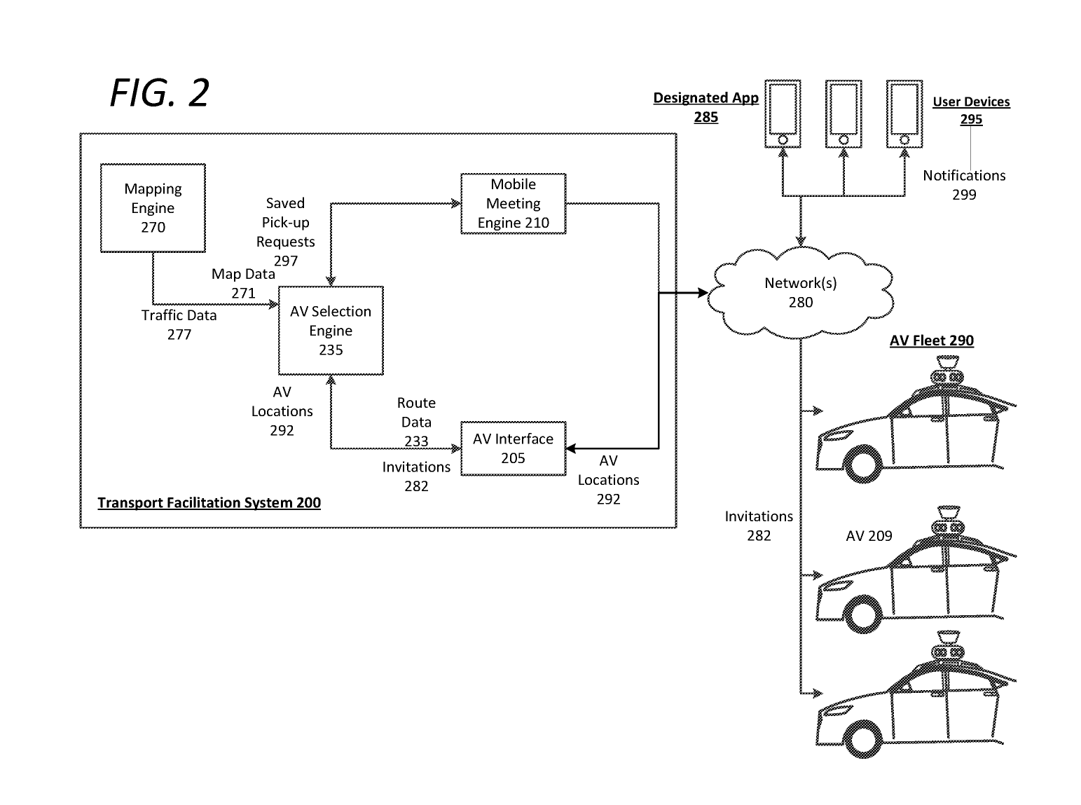

FIG. 2 is a block diagram illustrating an example transport facilitation system in communication with user devices and a fleet of vehicles, as described herein. The transport facilitation system 200 can include a mobile meeting engine 210 to communicate with the user devices 295 and an AV interface 205 to communication with a fleet of autonomous vehicles (AVs) 290 over a number of networks 280. In addition or in variations, the transport facilitation system 200 can communicate with human drivers operating service vehicles to facilitate transportation in accordance with a transportation arrangement service managed by the transport facilitation system 200. In many examples, the transport facilitation system 200 can provide the transportation arrangement service to link requesting users with service vehicles and/or AVs in the AV fleet 290 managed by the transport facilitation system 200. A designated application 285 corresponding to the transportation arrangement service can be executed on the user devices 295. A requesting user can provide an input on a user device 295 to transmit a pick-up request to the transport facilitation system 200. The pick-up request can be received by a communications interface and sent to a selection engine 235, which can match the requesting user with a proximate AV from the fleet 290.

In the context of a mobile meeting, mobile meeting engine 210 stores pick-up requests for scheduled meetings when meeting participants confirm their intention to attend the mobile meeting. Each of these saved pick-up requests 297 includes a pick-up location (e.g., a home or work address) where a selected AV 209 can rendezvous with the meeting participant. In many aspects, the AV 209 can be selected based on a proximity, distance, or time relative to the pick-up location. The fleet of AVs 290 can be dispersed throughout a given region (e.g., a city or metropolitan area) and transmit location data 292 to the AV interface 205 of the transport facilitation system 200. The AV interface 205 can transmit the vehicle locations 292 to the selection engine 235 in order to enable the selection engine 235 to determine candidate vehicles that can readily service the pick-up request 297.

Based on the pick-up location, the locations of proximate AVs in the fleet 290 or other proximate human-driven service vehicles, the selection engine 235 can select a vehicle (e.g., AV 209) to service the saved pick-up request 297. In addition, the number of meeting participants that are going to share the vehicle and a specific service level requested can also determine which vehicle is selected. In certain aspects, the selection engine 235 can further utilize a mapping engine 270 to identify a most optimal vehicle (e.g., AV 209) based on map data 279 (e.g., a distance to the pick-up location) and/or traffic data 277 (e.g., a time to reach the pick-up location). Upon selecting AV 209 as being the most optimal vehicle, the selection engine 235 can transmit an invitation 282 to AV 209 to service the saved pick-up request 297. In some examples, AV 209 can accept or deny the invitation depending on a number of factors (e.g., remaining fuel or energy, service indicators, owner requirements, etc.). In certain implementations, when AV 209 accepts the invitation 282, the transport facilitation system 200 can utilize the map data 279 and traffic data 277 to provide AV 209 with route information indicating a shortest or most optimal route to the pick-up location. Alternatively, AV 209 may be provided with local mapping resources to identify the most optimal route independently.

After AV 209 accepts the invitation 282 to service the saved pick-up request 297, the mobile meeting engine 210 can generate a notification 299 for the meeting and the incoming AV 209 for transmission to the user device 295 over the network 280. In one example, the notification 299 can include identifying information of the selected AV 209, such as the vehicle type, license plate number, vehicle color, time delta to the pick-up location, and the like. In other examples, the notification 299 can include security authentication details so that the AV 209 and user device 295 can perform a security handshake when the AV 209 arrives at the pick-up point. The notification 299 can be displayed to the meeting participant via the designated application 285 on a display screen of the user device 295.

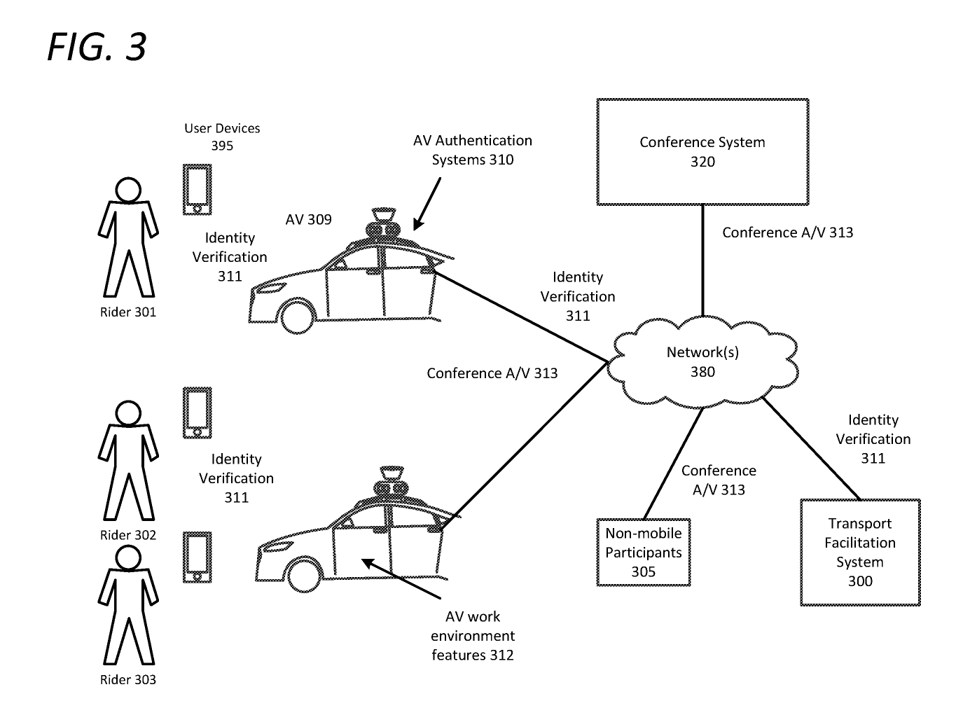

FIG. 3 is a block diagram illustrating a fleet of vehicles providing vehicle work environments for riders in communication with a conference system, as described herein. Autonomous vehicles (AV) 309 are sent to pick up riders 301, 302, 303, who may be participants in a mobile meeting scheduled through calendaring systems and a transport facilitation system as described in FIGS. 1 and 2. Each of the AVs 309 can provide a vehicle work environment including secure audio and visual communications with a conference system 320 between vehicles and any non-mobile participants 305 (e.g., participants in a conference room or using a desktop computer in an office). The vehicle work environment opens up more options for meetings and allows workers to spend their travel time productively.

AVs 309 can come equipped with various security authentication systems 310 to ensure that only authorized employees have access to meetings and confidential systems. In some aspects, AVs 309 enforce one or more security protocols between each rider's user device 395 and the AV authentication systems 310 to ensure that the correct rider 301, 302, 303 is in the correct AV 309. As described in FIGS. 1 and 2, the transport facilitation system 300 can store and verify security credentials for user devices 395, which may be tied to an individual user account or designated application.

In one implementation, AV authentication systems 310 perform identity verification 311 by implementing a handshaking session between the user device 395 and a transmitter/receiver on the AV 309 to exchange security credentials managed by the transport facilitation system 300. For each pickup scheduled, the transport facilitation system 300 can generate a unique security code (e.g., an AV approach light code, view finder light acknowledgement, or a unique service set identifier (SSID)). In addition, an application on the user device 395 can send identification credentials, such as a Wi-Gig or Bluetooth media access control (MAC) address or SSID, to the transport facilitation system 300. Transport facilitation system 300 sends the unique security code and identifiers for the AV 309 (e.g., the AV Wi-Gig/Bluetooth MAC or an SSID) to the user device 395. Furthermore, transport facilitation system 300 sends the unique security code and identifiers for the user device 395 to the AV 309.

When the AV 309 arrives to pick up the rider, AV authentication systems 310 can perform the handshaking session over a radio connection such as Wi-Gig, BlueTooth, or Wi-Fi and request a MAC address and/or SSID from the user device 395. Similarly, the AV 309 transmits its security credentials to the user device 395 for a two-way verification.

In another implementation, the security handshake between the user device 395 and AV 309 can use an infrared light based handshaking session using a phone light and vehicle light bar.

In another implementation, the security handshake between the user device 395 and AV 309 can use a Near-field Communication (NFC) protocol at the door or inside the AV 309.

In another implementation, the security handshake between the user device 395 and AV 309 can use a quick response (QR) code in the vehicle using the designated application on the user device 395 and a camera provided with the AV 309 as a QR scanner.

In another implementation, the security handshake between the user device 395 and AV 309 can use audio tones, either audible to people or ultrasonic tones, between the designated application on the user device 395 and the AV 309 or a driver application in examples where a mobile meeting is conducted with a driver in the vehicle.

In another implementation, the security handshake between the user device 395 and AV 309 can also use further login authentication, such as a username and password combination from the rider, on a computing device provided with the AV 309.

Once the security handshake is successful, the AV 309 provides secure network access for riders over network 380 to the conference system 320. In other aspects, AV 309 can automatically provide secure network access to an employer's network through a virtual private network (VPN), which employers can enable and configure through the transport facilitation system 300. If a mobile meeting is scheduled, AVs 309 can automatically join the meeting through the conference system 320 and provide conference audio and video 313 between each of the AVs 309 participating in the meeting and the conference system 320.

In addition to the AV authentication systems 310, AVs 309 can furnish AV work environment features 312 to optimize a rider's mobile meeting or commute in general to be more productive. For example, AVs 309 can provide a tele-conferencing system with audio and video to allow a rider 301 in one AV 309 to have a meeting with riders 302 and 303 in another AV 309 along with any non-mobile participants 305. AV work environment features 312 can also include ergonomic features that facilitate work and conference productivity, such as swivel seating, dimmable lighting, privacy glass, work surfaces, power and data for personal computing, mutable individual microphone pickups per rider position, virtual or augmented reality headsets, and human input device motion tracking sensors. The AV 309 can also provide virtual reality tracking data along with audio and video to facilitate virtual reality meetings.

Methodology

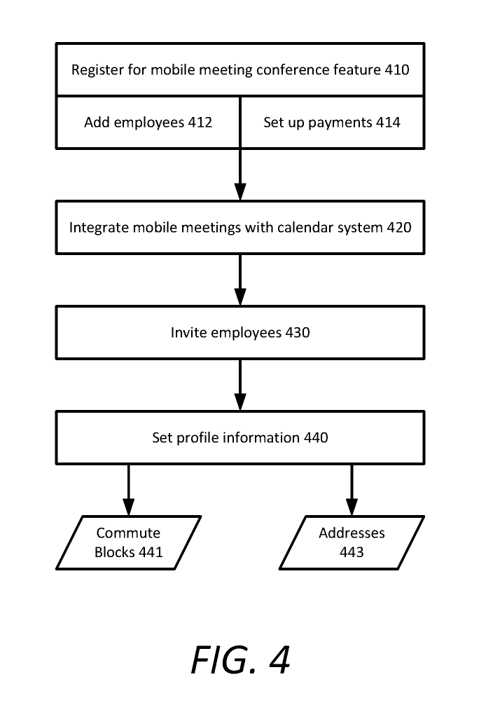

FIGS. 4-6 illustrate example methods for establishing profile information, creating a meeting with mobile participants, and facilitating a mobile meeting in a vehicle work environment, according to some aspects. While operations of the methods are described below as being performed by specific components, modules, or systems, it should be appreciated that these operations need not necessarily be performed by the specific components identified, and could be performed by a variety of components and modules, potentially distributed over a number of machines. Accordingly, references may be made to elements of transport facilitation system 100 and calendaring system 150 for the purpose of illustrating suitable components or elements for performing a step or sub step being described. Alternatively, at least certain ones of the variety of components and modules described in transport facilitation system 100 and calendaring system 150 can be arranged within a single hardware, software, or firmware component. It should also be appreciated that some of the steps of these methods may be performed in parallel or in a different order than illustrated.

FIG. 4 is a flow chart describing an example method of establishing profile information for employers and workers in a vehicle work environment. According to some aspects, an employer 125 can register with transport facilitation system 100 to support mobile meetings for its employees (410). Employers 125 provide employee data 131 for users 121 to have access to the mobile meeting feature in the calendaring system 150 (412). Employee data 131 can include information that mobile meeting logic 160 uses to suggest meeting times and coordinate vehicles with the transport facilitation system 100, such as user credentials, home and work addresses, business hours, etc. Employer 125 can also enter payment info 133, such as a company credit card or bank account, to which transport facilitation system 100 bills rides that employees take (414). Employee data 131 and payment info 133 can be stored in a database 140 with the transport facilitation system 100 as an employer profile 142. In one implementation, an employer 125 can enable the mobile meeting feature in a calendaring system 150 customized for their company (420). In other implementations, employer 125 downloads a plug-in module for mobile meeting logic 160 and installs it into the calendaring system 150.

In one aspect, users 121 invited to participate in the mobile meeting feature are sent emails to confirm their registration and provide profile data 144 (430). For example, users 121 can provide or update addresses on the calendar interface 152. Invited employees then enter their preferences for blocks of commute hours in which they may be available for in-commute conference meetings or general work presence. Combined with each employee's home and work addresses (443), these preferences are sent to the transport facilitation system 100 and added to a commute block (441) table in a database 140. In other aspects, profile data 144 is stored locally with the calendaring system 150 in addition to or in lieu of storing it with transport facilitation system 100.

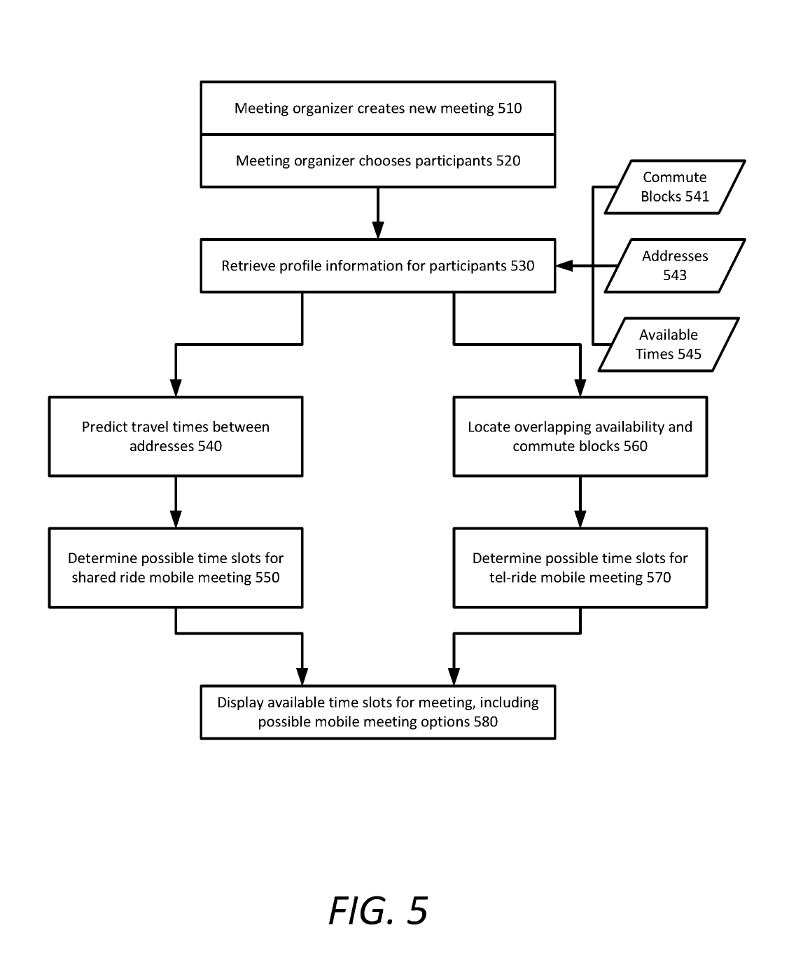

FIG. 5 is a flow chart describing an example method of a meeting organizer creating a meeting with mobile participants in a vehicle work environment. According to some aspects, a meeting organizer 123 accesses the calendaring system 150 through calendar interface 152 to create a new meeting (510). Calendaring system 150 can then prompt the meeting organizer 123 to choose desired participants for the meeting (520).

In addition to the usual conference rooms available as locations for the meeting, mobile meeting logic 160 mines travel profiles 145 for commute blocks (541), participant addresses (543) and available times (545) for each of the users 121 chosen for the meeting.

In order to generate the suggested mobile meeting options, mobile meeting engine 110 on the transport facilitation system 100 uses an algorithm to predict travel times and find overlapping time blocks in which participants are traveling. To determine the possibility of holding a meeting with multiple participants in the same vehicle, the mobile meeting engine 110 can utilize a mapping engine 170 to provide map data 171 and also retrieve historical data 141 from the database 140 that includes historical travel time information. Based on the pick-up addresses of two of the participants (e.g., a home address for a morning commute meeting), mobile meeting engine 110 predicts the travel time between the pick-up addresses from the map data 171 and historical data 141 (540). If the predicted travel time is below an acceptable threshold, mobile meeting logic 160 displays an option for a shared ride meeting between the selected participants on the calendar interface 152 for possible time slots (550). In some aspects, the acceptable threshold is an amount of time that allows a vehicle to pick up each of the shared ride meeting participants during their set commute blocks and also arrive at their destination address during their set commute blocks with enough time spent traveling for the meeting to take place. In other aspects, the acceptable threshold can extend commute blocks by a number of minutes in order to accommodate the shared ride meeting.

If the meeting organizer 123 creates a meeting request 135 for a shared ride meeting on the calendar interface 152, mobile meeting logic 160 can create meeting invitations with each invitation offset by the predicted travel time. For example, if the meeting organizer 123 creates a meeting request 135 for a 7:20 am meeting with a predicted travel time of 20 minutes between two participants, mobile meeting logic 160 can generate an invitation for a 7:00 am pick-up at the first participant's home address and an invitation for a 7:20 am pick-up at the second participant's home address. Upon receiving confirmation from the participants, mobile meeting engine 110 can log vehicle request orders for the meeting. In the above example, the mobile meeting engine 110 logs a request to send a vehicle to the first participant's home address by 7:00 am with further destinations of the second participant's home address and their work address.

To determine the possibility of holding a meeting with multiple participants in separate vehicles, the mobile meeting engine 110 analyzes travel profiles 145 for the meeting participants to find time blocks representing overlapping commute blocks between the participants (560). If there is an overlap large enough to accommodate the length of the proposed meeting, mobile meeting logic 160 displays time slot options for a multi-vehicle mobile meeting on the calendar interface 152 (570). For example, if the meeting organizer 123 creates a meeting request 135 for a multi-vehicle mobile meeting at 7:20 am, mobile meeting logic 160 can generate an invitation for a 7:20 am pick-up at the first participant's home address and an invitation for a 7:20 am pick-up at the second participant's home address. Upon receiving confirmation from the participants, mobile meeting engine 110 can log vehicle request orders for the meeting. In this example, the mobile meeting engine 110 logs two requests: the first to send a vehicle to the first participant's home address by 7:20 am, and the second to send a vehicle to the second participant's home address by 7:20 am.

Although the examples described are for a meeting between two participants, mobile meeting logic 160 and the mobile meeting engine 110 can predict travel times and schedule mobile meetings between any number of participants using the same logic. In addition, a meeting request 135 can include both a shared ride meeting and a multi-vehicle mobile meeting. For example, two participants can ride in one vehicle with a third participant in a separate vehicle tele-conferenced with the other vehicle.

Mobile meeting logic 160 then sends suggestions for multi-attendee mobile meeting time slots from the transport facilitation system 100 to the meeting organizer 123 to be displayed on the calendar interface 152 (580).

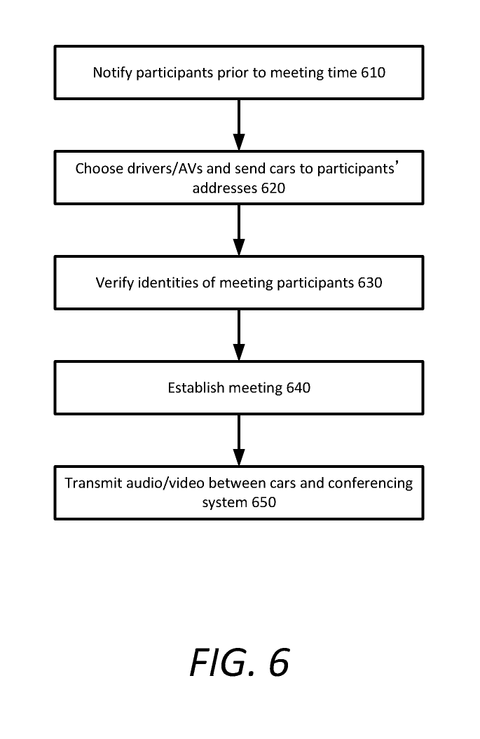

FIG. 6 is a flow chart describing an example method of facilitating a mobile meeting in a vehicle work environment. According to some aspects, the transport facilitation system sends a notification for the meeting to each of the meeting participants prior to the meeting time (610). For example, after an autonomous vehicle (AV) accepts the invitation 282 to service the saved pick-up request 297, the mobile meeting engine 210 can generate a notification 299 for the meeting and the incoming AV for transmission to the user device 295 over the network 280 (620). In one example, the notification 299 can include identifying information of the selected AV, such as the vehicle type, license plate number, vehicle color, time delta to the pick-up location, and the like. In other examples, the notification 299 can include security authentication details so that the AV 209 and user device 295 can perform a security handshake when the AV 209 arrives at the pick-up point. The notification 299 can be displayed to the meeting participant via the designated application 285 on a display screen of the user device 295.

AVs 309 can come equipped with various security authentication systems 310 to ensure that only authorized employees have access to meetings and confidential systems. In some aspects, AVs 309 enforce one or more security protocols between each rider's user device 395 and the AV authentication systems 310 to verify the identifies of each of the meeting participants (630). As described in FIGS. 1 and 2, the transport facilitation system 300 can store and verify security credentials for user devices 395, which may be tied to an individual user account or designated application.

In one implementation, AV authentication systems 310 perform identity verification 311 by implementing a handshaking session between the user device 395 and a transmitter/receiver on the AV 309 to exchange security credentials managed by the transport facilitation system 300. For each pickup scheduled, the transport facilitation system 300 can generate a unique security code (e.g., an AV approach light code, view finder light acknowledgement, or a unique service set identifier (SSID)). In addition, an application on the user device 395 can send identification credentials, such as a Wi-Gig or Bluetooth media access control (MAC) address or SSID, to the transport facilitation system 300. Transport facilitation system 300 sends the unique security code and identifiers for the AV 309 (e.g., the AV Wi-Gig/Bluetooth MAC or an SSID) to the user device 395. Furthermore, transport facilitation system 300 sends the unique security code and identifiers for the user device 395 to the AV 309.

Once the security handshake is successful, the AV 309 provides secure network access for riders over network 380 to the conference system 320 (640). In other aspects, AV 309 can automatically provide secure network access to an employer's network through a virtual private network (VPN), which employers can enable and configure through the transport facilitation system 300. If a mobile meeting is scheduled, AVs 309 can automatically join the meeting through the conference system 320 and provide conference audio and video 313 between each of the AVs 309 participating in the meeting and the conference system 320 (650).

Computer System

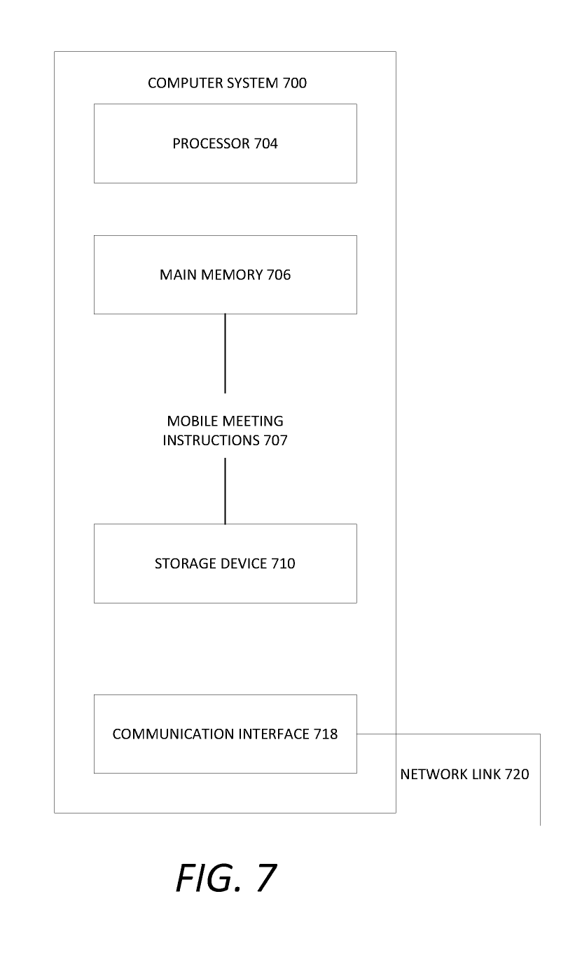

FIG. 7 is a block diagram that illustrates a computer system upon which aspects described herein may be implemented. For example, in the context of FIG. 1, transport facilitation system 100 and calendaring system 150 may be implemented using one or more servers such as described by FIG. 7.

In an aspect, computer system 700 includes processor 704, memory 706 (including non-transitory memory), storage device 710, and communication interface 718. Computer system 700 includes at least one processor 704 for processing information. Computer system 700 also includes the main memory 706, such as a random access memory (RAM) or other dynamic storage device, for storing information and instructions to be executed by processor 704. Main memory 706 also may be used for storing temporary variables or other intermediate information during execution of instructions to be executed by processor 704. Computer system 700 may also include a read only memory (ROM) or other static storage device for storing static information and instructions for processor 704. The storage device 710, such as a magnetic disk or optical disk, is provided for storing information and instructions. The communication interface 718 may enable the computer system 700 to communicate with one or more networks through use of the network link 720 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Examples described herein are related to the use of computer system 700 for implementing the techniques described herein. According to one aspect, those techniques are performed by computer system 700 in response to processor 704 executing one or more sequences of one or more instructions (e.g., mobile meeting instructions 707) contained in main memory 706. Such instructions may be read into main memory 706 from another machine-readable medium, such as storage device 710. Execution of the sequences of instructions contained in main memory 706 causes processor 704 to perform the process steps described herein. In alternative aspects, hard-wired circuitry may be used in place of or in combination with software instructions to implement aspects described herein. Thus, aspects described are not limited to any specific combination of hardware circuitry and software.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A mobile meeting system comprising:
one or more processors; and
one or more memory resources storing instructions that, when executed by the one or more processors, cause the one or more processors to:
receive a request over a network from an organizer to propose a meeting between a plurality of participants;
retrieve a travel profile for each of the plurality of participants; and
transmit the travel profiles over the network to the organizer, wherein the travel profiles indicate one or more blocks of time when each participant is commuting and also available for the meeting.

2. The mobile meeting system of claim 1, further comprising instructions that, when executed by the one or more processors, cause the one or more processors to:
receive an indication for a mobile meeting and a meeting time from the organizer;
schedule the mobile meeting at the meeting time; and
scheduling one or more vehicles to pick up at least some of the plurality of participants prior to the meeting time.

3. The mobile meeting system of claim 2, wherein the travel profiles include a home address and a work address for each participant and the one or more vehicles are sent to one of the home address or the work address for each participant.

4. The mobile meeting system of claim 2, wherein the one or more vehicles are selected optimally to coincide with each of the plurality of participants' travel profiles.

5. The mobile meeting system of claim 2, further comprising instructions that, when executed by the one or more processors, cause the one or more processors to:
verify identify information for the plurality of participants; and
establish a secure networked meeting between the one or more vehicles at the meeting time.

6. The mobile meeting system of claim 5, wherein the secure networked meeting uses a virtual private network.

7. The mobile meeting system of claim 1, wherein the one or more blocks of time in the travel profiles are submitted by each of the plurality of participants.

8. The mobile meeting system of claim 1, wherein each participant is only available for the meeting when that participant can use a transport facilitation service and is not driving.

9. A method of arranging a mobile meeting, the method being implemented by one or more processors and comprising:
receiving a request over a network from an organizer to propose a meeting between a plurality of participants;
retrieving a travel profile for each of the plurality of participants; and
transmitting the travel profiles over the network to the organizer, wherein the travel profiles indicate one or more blocks of time when each participant is commuting and also available for the meeting.

10. The method of claim 9, further comprising:
receiving an indication for a mobile meeting and a meeting time from the organizer;
scheduling the mobile meeting at the meeting time; and
scheduling one or more vehicles to pick up at least some of the plurality of participants prior to the meeting time.

11. The method of claim 10, wherein the travel profiles include a home address and a work address for each participant and the one or more vehicles are sent to one of the home address or the work address for each participant.

12. The method of claim 10, wherein the one or more vehicles are selected optimally to coincide with each of the plurality of participants' travel profiles.

13. The method of claim 10, further comprising:
verifying identify information for the plurality of participants; and
establishing a secure networked meeting between the one or more vehicles at the meeting time.

14. The method of claim 13, wherein the secure networked meeting uses a virtual private network.

15. The method of claim 9, wherein the one or more blocks of time in the travel profiles are submitted by each of the plurality of participants.

16. The method of claim 9, wherein each participant is only available for the meeting when that participant can use a transport facilitation service and is not driving.

17. A non-transitory computer readable medium storing instructions that, when executed by one or more processors, cause the one or more processors to:
receive a request over a network from an organizer to propose a meeting between a plurality of participants;
retrieve a travel profile for each of the plurality of participants; and
transmit the travel profiles over the network to the organizer, wherein the travel profiles indicate one or more blocks of time when each participant is commuting and also available for the meeting.

18. The non-transitory computer readable medium of claim 17, further comprising instructions that, when executed by the one or more processors, cause the one or more processors to:
receive an indication for a mobile meeting and a meeting time from the organizer;
schedule the mobile meeting at the meeting time; and
scheduling one or more vehicles to pick up at least some of the plurality of participants prior to the meeting time.

19. The non-transitory computer readable medium of claim 18, wherein the travel profiles include a home address and a work address for each participant and the one or more vehicles are sent to one of the home address or the work address for each participant.

20. The non-transitory computer readable medium of claim 18, wherein the one or more vehicles are selected optimally to coincide with each of the plurality of participants' travel profiles.
